(19) United States
(12) Patent Application Publication
(10) Pub. No.: US 2022/0049108 A1
(43) Pub. Date: Feb. 17, 2022

(54) COATED SUBSTRATES WITH ATTACHED DOPANTS COBLASTED WITH PARTICLES AND DOPANT

(71) Applicant: PPG Industries Ohio, Inc., Cleveland, OH (US)

(72) Inventors: Arjen Vellinga, Amsterdam (NL); Venkateshwarlu Kalsani, Gibsonia, PA (US); Nicole Lynn Rakers, Wexford, PA (US); Arnold Nederlof, Santpoort-Noord (NL); Daniel Connor, Evans City, PA (US); Katherine M. Durgin, La Conner, WA (US); Kees van der Kolk, Uitgeest (NL); Jonathan P. Breon, Pittsburgh, PA (US); Justin J. Martin, Harrison City, PA (US)

(73) Assignee: PPG Industries Ohio, Inc., Cleveland, OH (US)

(21) Appl. No.: 17/299,926

(22) PCT Filed: Dec. 4, 2019
(86) PCT No.: PCT/US2019/064512

§ 371 Date: Jun. 4, 2021

Related U.S. Application Data
(60) Provisional application No. 62/775,255, filed on Dec. 4, 2018.

(51) Int. Cl. C09D 5/08; C09D 5/12; C09D 5/18; C09D 163/00; C09D 183/04; C09D 175/04; B24C 11/00; B24C 1/00

(52) U.S. Cl. CPC C09D 5/084; C09D 5/12; C09D 5/185; B24C 1/00; C09D 183/04; C09D 175/04; B24C 11/005; C09D 163/00

(57) ABSTRACT

The present invention is directed to a coated substrate comprising: (a) a surface that has been impacted with an abrasive particle and a dopant such that at least some portion of the surface becomes attached with the dopant; and (b) a film-forming layer on at least a portion of the impacted surface, wherein the film-forming layer has been deposited from a film-forming composition; wherein the surface is impacted substantially simultaneously with the abrasive particle and the dopant; and wherein when the dopant comprises iron phosphate, zinc phosphate, manganese phosphate, cerium oxide, the film-forming composition is not a two-component epoxy clear coat.

### FIELD OF THE INVENTION

The present invention relates to coated substrates being blast impacted by a dopant and a film forming layer, and related methods.

### BACKGROUND OF THE INVENTION

Outdoor structures such as wind turbines, bridges, towers, tanks, pipes and fleet vehicles such as railcars, buses, and trucks are constantly exposed to the elements and must be designed to endure temperature extremes, wind shears, precipitation, and other environmental hazards without significant damage or the need for constant maintenance, which may be time-consuming and costly. Likewise, marine structures such as ship hulls and off-shore oil rigs and wind turbines are also exposed to seawater as well as extreme weather and other environmental conditions, making them susceptible to corrosion. Chemical storage transport or processing tanks or pipes such as fuel tanks and pipe linings are also vulnerable to corrosion and/or coating attack by aggressive chemicals being carried within. More effective treatment and coating systems are continually being sought to meet the specification demands of these industrial structures.

### SUMMARY OF THE INVENTION

The present invention is directed to a coated substrate comprising: (a) a surface that has been impacted with an abrasive particle and a dopant such that at least some portion of the surface becomes impacted with the dopant; and (b) a first film-forming layer on at least a portion of the impacted surface, wherein the surface is impacted substantially simultaneously with the abrasive particle and the dopant, and wherein the dopant and film-forming layer are as described herein.

### DETAILED DESCRIPTION OF THE INVENTION

The present invention is directed to a coated substrate comprising a surface that has been impacted with an abrasive particle and a dopant such that at least some portion of the surface becomes attached with the dopant, and a film-forming layer on at least a portion of the surface, wherein the surface is impacted substantially simultaneously with the abrasive particle and the dopant. The film-forming layer has been deposited from a film-forming composition

Suitable substrates for use in the present invention include rigid metal substrates such as ferrous metals, aluminum, aluminum alloys, copper, brass, and other metal and alloy substrates. The ferrous metal substrates used in the practice of the present invention may include iron, steel, and alloys thereof. Non-limiting examples of useful steel materials include hot and cold rolled steel, galvanized (zinc coated) steel, electrogalvanized steel, thermal spray aluminum, thermal spray zinc, stainless steel, pickled steel, and combinations thereof. Profiled metals such as profiled steel are also suitable. By “profiled” is meant that the substrate surface has been physically modified such as by mechanically or chemically etching, abrading such as by sanding or blasting, carving, brushing, hammering, stamping, or punching, to affect the topography of the metal surface. Combinations or composites of ferrous and non-ferrous metals can also be used. For clarity, “profiled” as used in this context refers to substrates that have undergone some physical modification prior to being impacted with the abrasive particle and dopant as described herein. It will be appreciated that treatment according to the present invention will also change the profile of the substrate. Use of titanium as a substrate may be particularly excluded.

Before depositing any compositions upon the surface of the substrate, it is common practice, though not necessary, to remove foreign matter from the surface by thoroughly cleaning and degreasing the surface. Such cleaning typically takes place after forming the substrate (stamping, welding, etc.) into an end-use shape. The surface of the substrate can be cleaned by physical or chemical means, such as mechanically abrading the surface or cleaning/degreasing with commercially available alkaline or acidic cleaning agents that are well known to those skilled in the art, such as sodium metasilicate and sodium hydroxide. A non-limiting example of a cleaning agent is CHEMKLEEN 163, an alkaline-based cleaner for metal substrates commercially available from PPG Industries, Inc.

Following the cleaning step, the substrate may be rinsed with deionized water or an aqueous solution of rinsing agents in order to remove any residue. The substrate can be air dried, for example, by using an air knife, by flashing off the water by brief exposure of the substrate to a high temperature or by passing the substrate between squeegee rolls.

The coated substrates of the present invention comprise (a) at least one surface of the substrate to which a dopant has been attached. “Attached”, as used herein, means the dopant is mechanically and/or chemically joined to or connected with the metal of the substrate surface. This attachment is distinct from a substrate to which applied dopant changes the chemical state of the substrate, such as, for example, in a conversion coating. The dopant material may also extend onto or above the metal surface. The impacting step may therefore also result in the formation of a continuous layer, a semi-continuous layer, or non-continuous deposits of dopant, or some altered form of the dopant, on the outmost surface of the substrate. For example, if the dopant is MgO or some other form of magnesium, a semi-continuous surface layer containing magnesium and oxide may be formed. A substrate may have one continuous surface, or two or more surfaces such as two opposing surfaces. Typically, the surface that is impacted with the attaching dopant and coated is any that is expected to be exposed to conditions susceptible to corrosion and/or chemical damage. Examples of particular substrates include a structure; a vehicle, industrial protective structure such as an electrical box enclosure, transformer housing, or motor control enclosure; railcar container, tunnel, oil or gas industry component such as platforms, pipes, tanks, vessels, and their supports, marine component, automotive body part, aerospace component, pipeline, storage tank, or wind turbine component. Additional examples include general purpose steel specimen like flat steel plates (pre-blasted before shop-primed) or structural steel construction elements like I- or H-bars. “Structure” as used herein refers to a building, bridge, oil rig, oil platform, water tower, power line tower, support structures, wind turbines, walls, and the like. “Vehicle” refers to in its broadest sense all types of vehicles, such as but not limited to cars, trucks, buses, tractors, harvesters, heavy duty equipment, vans, golf carts, motorcycles, bicycles, railcars, airplanes, helicopters, boats of all sizes and the like. Medical devices may be specifically excluded from the substrates of the present invention.

In particular examples of the present invention, the coated substrate comprises chemical storage, transport or processing tanks and/or pipes such as a fuel tank, a railcar tank used to store and transport, for example, oils and other hydrocarbons, and the surface or pipe attached with a dopant comprises an internal surface of the tank or pipe. Magnesium oxide has been found to be a particularly effective dopant for such applications, particularly when the storage tank is used to contain methanol, water, and palm oil fatty acid solutions; after impact with the dopant, a coating, such as an epoxy-amine tank liner may be applied. The storage tank may be made of steel.

A “dopant” as used herein is a compound that chemically and/or mechanically modifies the surface of the substrate to be treated. Suitable dopants include corrosion inhibitors, adhesion promoters, blister inhibitors, chemical resistant compounds, and/or temperature resistant compounds. Note that the phrase “and/or” when used in a list, and elsewhere in this specification, is meant to encompass alternative embodiments including each individual component in the list as well as any combination of components. For example, the list “A, B, and/or C” is meant to encompass seven separate embodiments that include A, or B, or C, or A+B, or A+C, or B+C, or A+B+C. The dopant may be solid and free flowing at ambient temperatures and in the form of particles of any desired size. For example, the dopant particles may have an average particle size of 20 to 100 microns, such as 20 to 50 microns. They may have a smaller particle size, such as 0.1 microns or greater, such as 0.1 to 100 microns. They may have a larger particle size, such as up to 700 microns, such as 300 to 700 microns. Particle sizes may be determined using laser diffraction techniques as known in the art. By “ambient” is meant surrounding conditions without the addition of any external heat or other energy. Often ambient temperature is called “room temperature”, ranging from 20 to 25° C. Specific examples of dopants include zinc phosphate, iron phosphate, magnesium compounds such as magnesium oxide, epoxy resins, zirconium dioxide, zinc oxide, silicon dioxide, and titanium dioxide. “Epoxy resins” as used in conjunction with the dopant material and the film-forming layer refers to any resin that has an epoxy (i.e. glycidyl functional group, can be polyepoxides, and includes as those derived from bisphenol A and bisphenol F, as well as novolac, resole and phenolic epoxies). Two or more dopants may be used to impact the substrate surface. For example, a corrosion inhibitor and adhesion promoter may both be used and delivered at substantially the same time or sequentially, for example. The dopant may be a non-solubilized particle and may be used in the form of a dry particle. Use of fatty acid as a dopant may be specifically excluded. Dopant may exclude therapeutic agents, and dopant may further exclude one or more of calcium phosphate in any form, titania, hydroxy apatite, silica, calcium carbonate, biocompatible glass, calcium phosphate glass, graphite, graphene, chitosan, chitin, barium titanate, and/or geolites.

“Corrosion inhibitors” refers to any compound that can minimize if not eliminate the onset of corrosion on a substrate. Examples of corrosion inhibitors include, for example, any one or more of the following: magnesium oxide, zinc phosphate, epoxy, iron phosphate, etc. The corrosion inhibitor may not contain zinc phosphate or iron phosphate.

“Adhesion promoters” refers to any compound that can increase the adhesion of a subsequent coating layer to a surface. An example of adhesion promoters include epoxies.

“Blister inhibitors” refers to any compound that prevents or decreases the frequency or size of blisters that form in or on the coating after exposure to environments such as high or low temperatures, high or low humidity, UV, salt fog, and/or water or chemical immersion for example. Examples of blisters can be found in ASTM D 714-02.

“Chemical resistant compounds” refers to any compound that prevents or decreases damage to a coating or substrate during exposure to any chemical substance such as water, alcohols, and/or fatty acids for example. Damage may include blisters, cracking, swelling, dissolving, lifting, peeling, delamination, softening, discoloration, loss of adhesion, erosion, wrinkling, etching, change in gloss, and/or rusting for example as is outlined in ASTM D6943. Examples of chemical resistant compounds include magnesium oxide, novolac epoxies and Bisphenol A and F epoxies

“Temperature resistant compounds” refers to any compound that prevents or decreases damage to a coating or substrate that is exposed to temperatures above or below 20-25 C.

Attachment of the dopant onto the substrate surface occurs by impacting the surface with the dopant and an abrasive particle. Suitable abrasive particles include but are not limited to metallic, plastic, glass, biobased, polymeric, and/or carbon based particles, particular examples of which may include shot or grit made from silica, sand, alumina, zirconia, zirconate, barium titanate, calcium titinate, sodium titanate, titanium oxide, glass, biocompatible glass, diamond, silicon carbide, boron carbide, dry ice, boron nitride, calcium phosphate, calcium carbonate, metallic powders, carbon fiber composites, polymeric composites, titanium, stainless steel, hardened steel, carbon steel chromium alloys, iron silicate, black beauty, starblast, garnet, diamond, plastic, walnut shell, corncob grit or any combination thereof. The use of glass particles may be excluded.

As noted above, the surface is impacted substantially simultaneously with the abrasive particle and the dopant; that is, the abrasive particle and the dopant are delivered to the surface to be treated at substantially the same time. For example, the abrasive particle and the dopant may be co-blasted at the surface of the substrate to be treated. In blasting, the dopant and the abrasive particles may each be delivered from one or more fluid jets at high speed, bombarding the surface of the substrate. The fluid jet may be generated, for example, from wet blasters or abrasive water jet peening machines operating at a pressure ranging from 0.5 to 100 bar, such as a pressure ranging from 1 to 30 bar, or a pressure ranging from 1 to 10 bar. Alternatively, the fluid jet may be generated from dry blasters, wheel abraders, grit blasters, sand blasters, or micro-blasters, operating at a pressure ranging from 0.5 to 100 bar, such as a pressure ranging from 1 to 30 bar, or a pressure ranging from 3 to 10 bar. Delivery of the dopant may be done in combination with the abrasive particles to enhance attachment of the dopant into and/or onto the substrate surface. Profiling of the substrate surface prior to or simultaneously with deposition of the dopant, such as by dry blasting, may also enhance attachment of the dopant into the substrate surface (that is, the surface could be profiled). The dopant material and the abrasive particles may be different material; this distinguishes over methods of applying a layer of metal, such as a protective metal, to a substrate by impinging the substrate with a particle wherein at least the outer surface of the particle is made from the same metal that is to be applied to the substrate. When the abrasive particles and dopants are delivered substantially simultaneously to the substrate surface, the action of the abrasive particles on the surface of the substrate allows for the attachment of the dopant into and/or onto the substrate surface. The abrasive and dopant do not have to be delivered to the surface through the same jet. They could be in any number of separate jets as long as they deliver the solid components to the surface at the substantially the same time, e.g., prior to reformation of any oxide layer. Alternatively, the abrasive particles can be delivered first, followed by the dopant.

Jet velocity, operating pressure, venturi configuration, angle of incidence and/or surface to nozzle distances may affect the extent of attachment of the dopant into the substrate surface. Additionally, the size, shape, density and hardness of the abrasive material used may also have an effect on the extent of attachment of the dopant into the surface of the substrate. The fluid stream itself, the blasting equipment using a gas medium (typically air), and/or the effects of using inert gases as a carrier fluid (e.g. N2 or noble gases such as Ar and He) may also influence the extent of attachment of the dopant into the substrate surface. The abrasive particles and dopant may be applied as described in WO 2015/140327.

It will be appreciated that impacting the surface of the substrate with an abrasive particle will cause the profile of the surface to change. The “profile” of the substrate refers to the difference between the highest and lowest points of the surface. Impacting the surface with the abrasive particle according to the present invention will cause this difference to increase. The amount of increase depends on the same factors discussed above in relation to the amount of attachment. The surface attached with a dopant typically demonstrates a cross-sectional profile of 0.1 to 5 mils (2.54 to 127 microns) prior to application of the film-forming composition as determined by ASTM D4417-14: Standard Test Methods for Field Measurement of Surface Profile of Blast Cleaned Steel (2014). A layer or deposit of dopant on the substrate surface may have a thickness of 0.1 to 15 microns although thicker layers/deposits are also possible. The dopant-attached surface of the present invention may, for example, have a cross-sectional profile of less than 1.5 mils (38.1 microns). In a particular example of the present invention, a magnesium oxide dopant may be coblasted onto a substrate surface in combination with an aluminum oxide abrasive, and the impacted surface demonstrates an average cross-sectional profile of less than 1.5 mils (38.1 microns), such as 1 to 1.3 mils (25.4 to 33.0 microns) prior to application of the film-forming composition.

At least one film-forming layer is applied to at least a portion of the impacted substrate surface. The film-forming layer can be deposited from a composition that may be curable. Suitable film-forming compositions may be solventborne or waterborne liquids, 100% solids, or may be solid, particulate powders. The term “curable”, as used for example in connection with a curable composition, means that the indicated composition is polymerizable or cross linkable through functional groups, e.g., by means that include, but are not limited to, thermal (including ambient cure) and/or catalytic exposure, or though evaporation, coalescence, oxidative crosslinking and the like. The term “cure”, “cured” or similar terms, as used in connection with a cured or curable composition, e.g., a “cured composition” of some specific description, means that at least a portion of the polymerizable and/or crosslinkable components that form the curable composition is polymerized and/or crosslinked. Additionally, curing of a polymerizable composition refers to subjecting said composition to curing conditions such as but not limited to thermal curing, leading to the reaction of the reactive functional groups of the composition, and resulting in polymerization and formation of a polymerizate. When a polymerizable composition is subjected to curing conditions, following polymerization and after reaction of most of the reactive end groups occurs, the rate of reaction of the remaining unreacted reactive end groups becomes progressively slower. The polymerizable composition can be subjected to curing conditions until it is at least partially cured. The term “at least partially cured” means subjecting the polymerizable composition to curing conditions, wherein reaction of at least a portion of the reactive groups of the composition occurs, to form a polymerizate. The polymerizable composition can also be subjected to curing conditions such that a substantially complete cure is attained and wherein further curing results in no significant further improvement in polymer properties, such as hardness. The term “reactive” refers to a functional group capable of undergoing a chemical reaction with itself and/or other functional groups spontaneously or upon the application of heat or in the presence of a catalyst or by any other means known to those skilled in the art. By “polymer” is meant a polymer including homopolymers and copolymers, and oligomers. By “composite material” is meant a combination of two or more different materials.

Any suitable film-forming composition can be used according to the present invention, as further described. As used herein, the term “film-forming resin” refers to resins that can form a self-supporting continuous film on at least a horizontal surface of a substrate upon removal of any diluents or carriers present in the composition or upon curing at ambient or elevated temperature.

Film-forming resins that may be used in the present invention include, without limitation, those used in automotive OEM coating compositions, automotive refinish coating compositions, industrial coating compositions, architectural coating compositions, coil coating compositions, packaging coating compositions, protective and marine coating compositions, and aerospace coating compositions, among others. The epoxy resin and amine together comprise a film-forming resin.

It is also possible to use one or more additional film-forming resins in the coating. Additional film-forming resins that may be used include, without limitation, those used in aerospace coating compositions, automotive OEM coating compositions, automotive refinish coating compositions, industrial coating compositions, architectural coating compositions, and coil coating compositions, among others. Additional film-forming resins suitable for use in the coating compositions of the present invention include, for example, resins based on acrylic, saturated or unsaturated polyester, alkyd, polyurethane or polyether, polyvinyl, cellulosic, silicon-based polymers, co-polymers thereof, which resins may contain reactive groups such as epoxy, carboxylic acid, hydroxyl, isocyanate, amide, carbamate, amine and carboxylate groups, inorganic zinc silicates, among others, including mixtures thereof. Combinations of film-forming resins can be used. For example, the additional film-forming resin included in the epoxy coating compositions used in the present invention may comprise a resin with functionality that will cure with the amine, or alternatively, one or more additional crosslinkers can be used. Suitable crosslinkers can be determined by those skilled in the art based on the additional resin(s) chosen. Additionally, the film-forming composition may be electrodeposited by anodic or cathodic processes and contain acrylic and/or epoxy compositions. The film-forming composition may be a thermoplastic powder. The thermoplastic powder composition may contain vinyl resins such as PVC and/or PVDF and/or polyolefinic resins for example polyethylene and polypropylene. Furthermore, the thermoplastic powder composition may contain nylon based (i.e. polyamide) resin as well as polyester resins. The film-forming composition may be a thermoset powder. Thermoset powder compositions may contain epoxy and/or novolac epoxy resins with functional groups containing but not limited to carboxylic acid functionality, amine functionality, acid anhydrides, dicyandiamide, and/or phenolic functionality. Thermoset powder compositions may also contain polyester resins with hydroxyl functionality and/or carboxylic functionality. Thermoset powder compositions may also contain acrylic resins with GMA functionality, hydroxyl functionality, and/or carboxylic functionality. Thermoset powder composition may also contain silicone-based polyesters. Thermoset and thermoplastic powder compositions may be applied electrostatically and/or by thermal spray.

The film-forming composition may be intumescent; i. e., it may swell or char when exposed to a flame, thus exhibiting flame retardant properties. Intumescent coatings are used on many structures to delay the effects of a fire. The coating slows the rate of temperature increase of the substrate to which the coating is applied. The coating thus increases the time before the structure fails due to the heat of fire. The extra time makes it more likely that fire fighters will be able to extinguish the fire or at least apply cooling water before the structure fails. Intumescent coatings generally contain some form of resinous binder, for example a high-temperature polymer such as an epoxy resin and an appropriate crosslinker. The resinous binder forms the hard coating. If an epoxy resin is present in the binder, the binder also provides a source of carbon, which, in a fire, is converted to a char. In addition, the coating contains additives called “spumifics” that give off gas in a fire, which causes the char to swell into a foam. The efficacy of the coatings is related to the formation, due to the action of heat, of a thick and porous char foam which operates as a conventional insulator. Thus, it is a very important requirement of an intumescent coating composition to have the ability to uniformly form a carbonaceous char during a fire, which will adhere to the substrate without cracking. Curing agents that are often used to cure polyepoxide resins in intumescent coating compositions comprise polyamines. In such systems comprising epoxy resins and polyamine curing agent, the speed of cure can be slow, limiting both overcoat time and time for return to service. This problem is magnified in low temperature application conditions where the cure is slowed even further.

In particular examples of the present invention, the film-forming composition may comprise a polysiloxane, alone or in combination with an epoxy resin; a polyurethane; an epoxy resin, a polyester, a polyaspartic functional polymer, and/or a polyurea. Epoxy resins are often used in a pigmented primer and/or a pigmented coat or topcoat composition. For example the dopant may comprises a corrosion inhibitor other than iron phosphate and the first film-forming composition may comprises a polysiloxane or a polyurethane. The dopant may comprise a corrosion inhibitor and the first film-forming composition may comprise zinc

An example of a commercially available film-forming composition comprising a polysiloxane is PSX 700 (commercially available from PPG), an engineered siloxane coating that also contains some epoxy resin, manufactured according to U.S. Pat. Nos. 5,618,860 and 5,275,645. Suitable film-forming compositions comprising polyurethane include SPM76569, a direct-to-metal coating composition available from PPG; W43181A, a polyurethane primer available from PPG; and HPP2001, a high-performance polyurethane primer available from PPG. Suitable pigmented polyepoxide compositions include AMERLOCK 400, an epoxy primer available from PPG; PHENGUARD 930/935/940 and NOVAGUARD 840, epoxy tank liners available from PPG; and SEP74860, an epoxy primer available from PPG. In some cases, such as when the film-forming composition comprises a polysiloxane and optionally a polyepoxide, the composition may be applied directly to the dopant-attached surface with no intervening layer, thereby eliminating the need to use a primer and/or mid-coat. The performance may be comparable if not better than that observed with a substrate that has been treated with an epoxy primer and the same polysiloxane top coat applied in a conventional manner.

The film-forming composition in contact with the impacted surface typically demonstrates a pigment to binder ratio (P:B) of 0.1:1 to 35:1, such as 0.5:1 to 3.0:1. When the coated substrate comprises a storage tank lining, the film-forming composition can have a pigment volume concentration of 10 percent by volume to 50 percent by volume, such as 14 percent by volume to 40 percent by volume. The film-forming composition can be a clear coat, with less than 5% by volume, such as less than 2 or less than 1% by volume, of pigment, or no pigment at all (i.e. 0% by volume).

In a particular example of the present invention, the film-forming composition (b) applied to the impacted surface comprises a pre-fabrication shop coating or shop primer that is intended to provide protection during manufacturing and/or transport of an article. A shop primer or pre-fabrication primer is a temporary coating that is intended to provide protection from corrosion as a result of the elements or damages and scratches and the like. In many cases this pre-fabrication primer or shop primer is maintained as part of the final coating system. In highly demanding systems, like tank coatings for aggressive chemicals or potable water, these primers may be removed. An example of such a coating is a shop primer or holding primer, which optionally comprises a silicate or any other silicate. The pre-fabrication shop coating or shop primer may be left in place or may be a temporary coating that is removed prior to application of a permanent coating; i. e., the film-forming composition (b). TSA or TZA can be used as secondary “coatings”, such as for wind towers.

The coated substrates of the present invention may further comprise (c) a second film-forming layer on top of at least a portion of the film-forming layer (b). The second film-forming layer may be deposited from a composition that is pigmented or clear. As with the first film-forming composition, the second film-forming composition may be any suitable film-forming composition, such as those described above. In a particular combination, the first film-forming composition may comprise zinc and the second film-forming composition may comprise a polysiloxane optionally with epoxy resin. Film-forming compositions that contain zinc include inorganic zinc coatings that may further comprise silicate or any other ceramic, and zinc-rich primer coatings that may further comprise an organic material, such as an epoxy resin. Zinc-rich compositions typically comprise at least 40 percent by weight zinc metal, such as 50 to 90 percent by weight. AMERCOAT 68HS, available from PPG, is an example of a commercially available zinc-rich primer coating with a polyepoxide. When two or more coating layers are deposited, the two layers may be the same or different. The first coating composition may be completely or partially cured before application of the second coating composition, or may be applied “wet on wet” with little or no cure or only an air dry stop between application of the two coating layers.

In other combinations, the first film-forming composition comprises an epoxy resin, particularly one derived from Bisphenol A and/or Bisphenol F, and optionally zinc, and the second film-forming composition comprises a polyurethane; or the first film-forming composition comprises an epoxy resin derived from Bisphenol A and/or Bisphenol F and optionally zinc, and the second film-forming composition comprises a polysiloxane and optionally a polyepoxide. A polyurethane topcoat designed for automotive refinish and available from PPG as AUE-370, is particularly suitable over a primer comprising a polyepoxide such as CRE-321, available from PPG.

When curable compositions are used in the present invention, they can be prepared as a two-package composition, typically curable at ambient temperature. Two-package curable compositions are typically prepared by combining the ingredients immediately before use, or can be applied by dual feed equipment as well.

The compositions may be applied to the impacted substrate by one or more of a number of methods including spraying, dipping/immersion, brushing, and/or flow coating. For spraying, the usual spray techniques and equipment for air spraying, airless spraying, and electrostatic spraying and either manual or automatic methods can be used. The coating layer typically has a dry film thickness of a broad range; i. e., anywhere from 5 microns to 25.4 mm, depending on the particular industrial application. For example, an intumescent coating may have a dry film thickness of 500 to 1000 mils (12.7 to 25.4 mm). A pre-fabrication shop coating or shop primer may have a dry film thickness of 5 to 30 microns. A tank lining system may range from 60 to 1200 microns depending on the chemistry; such as 300 to 400 microns. A dry film thickness of 1000 to 1200 microns is typical for a tank lining system comprising a polyepoxide. In general, the dry film thickness of the coating may range from 2-25 mils (50.8-635 microns), often 5-25 mils (127-635 microns).

After forming a film of the coating on the substrate, the composition can be cured if necessary by allowing it to stand at ambient temperature, or a combination of ambient temperature cure, hot cure and baking. The composition can be cured at ambient temperature typically in a period ranging from 4 hours to as long as 2 weeks. If ambient humidity is below 40% relative humidity then cure times may be extended.

The coated substrates of the present invention may demonstrate corrosion resistance, scribe or damage creep resistance, enhanced adhesion, blister resistance, chemical resistance, and/or temperature resistance (i. e., resistance to damage by extreme temperatures) as compared to substrates that have not been impacted with dopant as described herein. They are applicable, for example, for use on a substrate surface (such as a ship hull or offshore oil rig) that is to be in contact with water, including seawater. Additionally, the coated substrate may demonstrate resistance to chemicals, both aggressive and non-aggressive chemicals as determined by chemical immersion testing in accordance with ISO 2812-1:2007 and/or ASTM D6943-15 (2015), as well as improvements in hot water resistance. Panels were inspected for an increase or decrease in coating damage compared to the control. Panels were inspected for blisters, cracking, swelling, delamination, softening, discoloration, adhesion, and under-film corrosion and then given a general rating based off of the overall performance compared to the control. Examples of aggressive chemicals include acids such as fatty acids, alcohols, and hydrocarbons, combinations and sequences thereof.

The coated substrates of the present invention may be prepared in a batch, or step-by-step process. The present invention is further drawn to a continuous process for preparing a coated substrate, comprising: (i) impacting at least one surface of the substrate with an abrasive particle and a dopant as described herein as the substrate moves along a conveyor, such that at least some portion of the surface becomes impacted with the dopant; (ii) applying a pre-fabrication shop coating or shop primer to the impacted surface as the substrate moves along a conveyor to form a coated substrate. The continuous method may find uses beyond pre-fab shop coating or primer. The dopant and the pre-fabrication shop coating or shop primer may be any of those disclosed above. The steps of impacting the dopant and applying the film-forming composition may be adapted to an existing continuous production line for manufacturing an industrial article. Substrates according to the present invention may also be all or a portion of an existing structure or vehicle. Repainting of such structures/vehicles typically occurs in the field and may include the removal of one or more existing coating layers prior to impacting the surface with dopant and applying a film forming layer as described herein. Such paint removal may be done by blasting the surface with an abrasive particle. According to the present invention, such a substrate can be blasted first with an abrasive particle alone and then with the abrasive particle and dopant according to the present invention to remove the existing paint and/or oxide layer in a first step and impacting the surface with the dopant in a second step, or the abrasive particle and dopant can be delivered so as to remove the existing paint and/or oxide layer and impacting the surface with dopant in one step.

It has been found that particular combinations of dopant(s) and film-forming layers demonstrate unexpected results with respect to corrosion inhibition, adhesion enhancement, blister resistance, and/or chemical resistance as enumerated below and as illustrated in the Examples. More specifically such results may be observed:
when the dopant comprises zinc phosphate and the first film-forming composition is any of the above described film-forming compositions, but is not a two-component epoxy clear coat,
when the dopant comprises zinc phosphate and the first film forming composition comprises a polysiloxane and optionally an epoxy resin,
when the dopant comprises zinc phosphate and the first film-forming composition comprises a polyurethane,
when the dopant comprises zinc phosphate and the first film-forming composition comprises an epoxy resin,
when the dopant comprises magnesium oxide and the first film-forming composition is any of the above described film-forming compositions,
when the dopant comprises magnesium oxide and the first film-forming composition comprises a polysiloxane and optionally an epoxy resin,
when the dopant comprises magnesium oxide and the first film-forming composition comprises an epoxy resin, which can be clear or pigmented;
when the dopant comprises a magnesium oxide and the first film-forming composition comprises a polyurethane;
when the epoxy resin comprises magnesium oxide and the first film-forming composition is any of the above described film-forming compositions,
when the dopant comprises an epoxy resin and the first film-forming composition is any of the above described film-forming compositions,
when the dopant comprises an epoxy resin and the first film-forming composition comprises a polysiloxane and optionally an epoxy resin,
when the dopant comprises an epoxy resin and the first film-forming composition comprises a polyurethane,
when the dopant comprises an epoxy resin and the first film-forming composition comprises an epoxy resin, which can be clear or pigmented,
when the dopant comprises iron phosphate and the first film-forming composition is any of the above described film-forming compositions, but is not a two-component epoxy clear coat,
when the dopant comprises iron phosphate and the first film-forming composition comprises pigmented epoxy resin,
when the dopant comprises iron phosphate and the first film-forming composition comprises a polyurethane,
when the dopant comprises cerium oxide, iron phosphate, manganese phosphate and/or zinc phosphate, and the first film-forming composition is any composition as described above, but is not a two-component epoxy clear coat.

Such results may also be observed when 2 or more film-forming layers are deposited, such as when:
the dopant comprises zinc phosphate, iron phosphate, magnesium oxide and/or epoxy resin, and each of the first and second coating compositions are any of the above described film-forming compositions, and the first and second coating compositions may be the same or different. The first and second coating compositions may be pigmented or clear, such as a first pigmented layer and a second clear layer,
the dopant comprises zinc phosphate, a first film-forming composition comprises zinc, and a second film-forming composition comprises a polysiloxane and optionally an epoxy resin; the first film-forming composition optionally further comprises an epoxy resin and/or a silicate or any ceramic,
the dopant comprises zinc phosphate, a first film-forming composition comprises a polyurethane, and a second film-forming composition comprises any coating composition, such as those described herein,
the dopant comprises zinc phosphate, a first film-forming composition comprises an epoxy resin, and a second film-forming composition comprises any coating composition, such as those described herein, especially a polyurethane,
the dopant comprises magnesium oxide, a first film-forming composition comprises an epoxy resin, and a second film-forming composition comprises any coating composition, such as those described herein, especially a polyurethane,
the dopant comprises a magnesium oxide, a first film-forming composition comprises zinc, and a second film-forming composition comprises a polysiloxane and optionally an epoxy resin, wherein the first film-forming composition optionally further comprises an epoxy resin and/or a silicate or any other ceramic,
the dopant comprises an epoxy resin, a first film-forming composition comprises an epoxide, and a second film-forming composition comprises any coating composition, such as those described herein; the epoxy resin of the dopant and the first film-forming composition may both be derived from bisphenol A, bisphenol F and/or novolac;
the dopant comprises an epoxy resin, a first film-forming composition comprises an epoxy resin, and a second film-forming composition comprises any coating composition, such as those described herein, wherein the first film forming composition optionally further comprises zinc and/or the second film forming composition optionally further comprises a polysiloxane and an epoxy resin or a polyurethane; the dopant may be a novolac epoxy and the first film-forming composition may be derived from bisphenol A; and
the dopant comprises an iron phosphate, a first film-forming composition comprises an epoxy resin, such as one derived from bisphenol A and/or bisphenol F, and a second film-forming composition comprises any coating composition, such as those described herein.

As used herein, unless otherwise expressly specified, all numbers such as those expressing values, ranges, amounts or percentages may be read as if prefaced by the word “about”, even if the term does not expressly appear. Any numerical range recited herein is intended to include all sub-ranges subsumed therein. Plural encompasses singular and vice versa. For example, while the invention has been described in terms of “a” polyester stabilizer, “an” ethylenically unsaturated monomer, “an” organic solvent, and the like, mixtures of these and other components, including mixtures of microparticles, can be used. Also, as used herein, the term “polymer” is meant to refer to prepolymers, oligomers and both homopolymers and copolymers; the prefix “poly” refers to two or more. When ranges are given, any endpoints of those ranges and/or numbers within those ranges can be combined with the scope of the present invention. “Including”, “such as”, “for example” and like terms means “including/such as/for example but not limited to”. The terms “acrylic” and “acrylate” are used interchangeably (unless to do so would alter the intended meaning) and include acrylic acids, anhydrides, and derivatives thereof, lower alkyl-substituted acrylic acids, e.g., C₁-C₂ substituted acrylic acids, such as methacrylic acid, ethacrylic acid, etc., and their C₁-C₆ alkyl esters and hydroxyalkyl esters, unless clearly indicated otherwise. The terms “(meth)acrylic” or “(meth)acrylate” are intended to cover both the acrylic/acrylate and methacrylic/methacrylate forms of the indicated material, e.g., a (meth)acrylate monomer. The term “(meth)acrylic polymer” refers to polymers prepared from one or more (meth)acrylic monomers.

Each of the characteristics and examples described above, and combinations thereof, may be said to be encompassed by the present invention. The present invention is thus drawn to the following non-limiting aspects:

1. A coated substrate comprising:
(a) a surface that has been impacted with an abrasive particle and a dopant such that at least a portion of the surface becomes attached with the dopant;
(b) a first film-forming layer on at least a portion of the dopant-attached surface, wherein the surface is impacted substantially simultaneously with the abrasive particle and the dopant.

2. The substrate of Aspect 1, wherein the dopant comprises a corrosion inhibitor.

3. The substrate of Aspect 2, wherein the dopant comprises magnesium oxide.

4. The substrate of Aspect 2, wherein the dopant comprises zinc phosphate.

5. The substrate of Aspect 2, wherein the dopant comprises iron phosphate.

6. The substrate of Aspect 2, wherein the dopant comprises an epoxy resin.

7. The substrate of Aspect 6, wherein the epoxy resin dopant is derived from Bisphenol A, bisphenol F and/or novolac.

8. A coated substrate comprising according to any preceding aspect wherein the first film-forming composition comprises a polysiloxane.

9. The coated substrate of Aspect 8, wherein the first film-forming composition further comprises an epoxy resin.

10. A coated substrate according to any preceding aspect, wherein the first film-forming composition comprises a polyurethane.

11. A coated substrate according to any preceding aspect wherein the first film-forming composition comprises an epoxy resin.

12. The coated substrate of Aspect 11 wherein, when the dopant comprises iron phosphate, zinc phosphate, manganese phosphate and/or cerium oxide, the epoxy resin is not a two-component epoxy clear coat.

13. The coated substrate of Aspects 11 or 12, wherein the epoxy resin is derived from Bisphenol A or bisphenol F.

14. The coated substrate of Aspects 11 or 12, wherein the epoxy resin comprises a novolac resin.

15. The coated substrate of any preceding aspect, wherein the first film-forming composition comprises zinc.

16. A coated substrate according to any preceding aspect, further comprising a second film-forming composition applied to at least a portion of the first film-forming layer.

17. The coated composition of Aspect 16, wherein the second film-forming composition comprises a polysiloxane.

18. The coated substrate of Aspect 17, wherein the second film-forming composition further comprises an epoxy resin, such as polyepoxide.

19. The coated substrate of aspect 16-18, wherein the second film-forming composition comprises a polyurethane.

20. A coated substrate comprising:
(a) a surface impacted with a dopant comprising magnesium oxide; and
(b) a first film-forming composition applied to the impacted surface, wherein the film-forming composition comprises an epoxy resin.

21. The coated substrate of Aspect 20, wherein the epoxy resin comprises polyepoxide and is optionally pigmented.

22. A coated substrate comprising:
(a) a surface impacted with a dopant comprising magnesium oxide; and
(b) a multi-layer coating comprising: (i) a first film-forming composition applied to the impacted surface, and (ii) a second film-forming composition applied on top of the first film-forming composition.

23. The coated substrate of Aspect 22, wherein the first film-forming composition comprises a polyepoxide derived from Bisphenol A, Bisphenol F and/or novolac.

24. The coated substrate of Aspect 23, wherein the second film-forming composition comprises a polyurethane.

25. A coated substrate comprising:
(a) a surface impacted with a dopant comprising magnesium oxide; and
(b) a multi-layer coating comprising: (i) a first film-forming composition applied to the impacted surface, wherein the first film-forming composition comprises zinc; and (ii) a second film-forming composition applied on top of the first film-forming composition, the second film-forming composition comprising a polysiloxane and optionally a polyepoxide.

26. The coated substrate according to Aspect 25, wherein the first film-forming composition further comprises a polyepoxide and/or a silicate or any other ceramic

27. A coated substrate comprising:
(a) a surface impacted with a dopant comprising magnesium oxide; and
(b) a first film-forming composition applied to the impacted surface, wherein the film-forming composition comprises a polyurethane.

28. The coated substrate of Aspect 27, further comprising (c) a second film-forming composition applied on top of the first film-forming composition (b).

29. The coated substrate of any of the preceding aspects, wherein the first film-forming composition in contact with the impacted surface has a pigment to binder ratio of 0.1:1 to 35:1.

30. The coated substrate of any of the preceding aspects, wherein the substrate comprises cold or hot rolled steel.

31. The coated substrate of any of the preceding aspects, wherein the substrate comprises profiled steel.

32. The coated substrate of any of the preceding aspects, wherein the substrate comprises at least a part of a structure.

33. The coated substrate of Aspects 1-31, wherein the substrate comprises at least a part of a vehicle.

34. The coated substrate of any of Aspects 1-33, wherein the substrate comprises at least part of a building, bridge, commercial vehicle, industrial protective structure, railcar, railcar container, water tower, power line tower, tunnel, oil or gas industry component, marine component, automotive body part, aerospace component, bridge support structure, pipeline, storage tank, or wind turbine component.

35. The coated substrate of any of the preceding aspects, comprising at least two dopants impacted in the substrate surface.

36. The coated substrate of any of Aspects 1-34, wherein the surface impacted with a dopant demonstrates a cross-sectional profile of 0.1 to 5 mils (2.54 to 127 microns) prior to application of the film-forming composition.

37. The coated substrate of any of Aspects 1-36, wherein the dopant deposited on the substrate surface has a thickness of 0.1 to 15 microns.

38. The coated substrate of any of Aspects 1-37, wherein at least one film-forming composition demonstrates intumescence.

39. The coated substrate of any of Aspects 1-33 or 35-38, wherein the coated substrate comprises a storage tank and the surface (a) impacted with a dopant comprises an internal surface of the tank.

40. The storage tank of Aspect 39, wherein the tank comprises a fuel tank.

41. A coated substrate according to any of the preceding aspects in which the film-forming layer comprises a pre-fabricated shop coating or shop primer.

42. The coated substrate of Aspect 41, wherein the pre-fabrication shop coating or shop primer comprises a shop primer, which optionally comprises a silicate or any other ceramic.

43. The coated substrate of any of Aspects 1-42, wherein the coated substrate demonstrates resistance to chemicals as measured by ISO 2812-1:2007 and/or ASTM D6943-15.

44. The coated substrate of Aspect 43, wherein the aggressive chemical comprises an acid.

45. The coated substrate of Aspect 43 wherein the aggressive chemical comprises an alcohol.

46. The coated substrate of Aspect 43 wherein the aggressive chemical comprises a hydrocarbon.

47. A coated substrate comprising:
(a) a surface impacted with a dopant comprising a novolac epoxy resin; and
(b) a first film-forming composition applied to the impacted surface, wherein the film-forming composition comprises a polyepoxide, wherein the coated substrate demonstrates resistance to a fatty acid as measured by ISO 2812-1:2007.

48. A continuous process for preparing a coated substrate, comprising:
(i) impacting at least one surface of the substrate with a dopant as the substrate moves along a conveyor; and
(ii) applying a pre-fabrication shop coating or shop primer to the impacted surface as the substrate moves along a conveyor to form a coated substrate.

49. The continuous process of Aspect 48, wherein the pre-fabrication shop coating or shop primer comprises a shop primer, which optionally comprises a silicate or any other ceramic.

50. Use of the coated substrate of any of the preceding aspects, wherein the coated substrate is in contact with water.

51. The use of a coated substrate of any of the preceding aspects, wherein the substrate surface is to be submerged in seawater.

52. A coated substrate comprising:
(a) a surface impacted with a dopant comprising zirconium dioxide, zinc oxide, silicon carbide, silicon dioxide, and/or titanium dioxide; and
(b) a first film-forming composition applied to the impacted surface, wherein the film-forming composition comprises a polyester, a polyaspartic functional polymer, and/or a polyurea.

53. A coated substrate comprising:
(a) a surface impacted with a dopant comprising zinc phosphate; and
(b) a multi-layer coating comprising: (i) a first film-forming composition applied to the impacted surface, wherein the first film-forming composition comprises zinc; and (ii) a second film-forming composition applied on top of the first film-forming composition, the second film-forming composition comprising a polysiloxane and optionally a polyepoxide.

54. A coated substrate comprising:
(a) a surface impacted with a dopant comprising zinc phosphate; and
(b) a first film-forming composition applied to the impacted surface, wherein the film-forming composition comprises an epoxy resin.

55. The coated substrate of Aspect 54, wherein the epoxy resin comprises polyepoxide and is optionally pigmented.

56. A coated substrate comprising:
(a) a surface impacted with a dopant comprising zinc phosphate; and
(b) a multi-layer coating comprising: (i) a first film-forming composition applied to the impacted surface, and (ii) a second film-forming composition applied on top of the first film-forming composition.

57. The coated substrate of Aspect 56, wherein the first film-forming composition comprises a polyepoxide derived from Bisphenol A, Bisphenol F and/or novolac.

58. The coated substrate of Aspect 56 or 57, wherein the second film-forming composition comprises a polyurethane.

59. A coated substrate comprising:
(a) a surface impacted with a dopant comprising zinc phosphate; and
(b) a multi-layer coating comprising: (i) a first film-forming composition applied to the impacted surface, wherein the first film-forming composition comprises zinc; and (ii) a second film-forming composition applied on top of the first film-forming composition, the second film-forming composition comprising a polysiloxane and optionally a polyepoxide.

60. The coated substrate according to Aspect 59, wherein the first film-forming composition further comprises a polyepoxide and/or a silicate or any other ceramic.

61. A coated substrate comprising:
(a) a surface impacted with a dopant comprising zinc phosphate; and
(b) a first film-forming composition applied to the impacted surface, wherein the film-forming composition comprises a polyurethane.

62. The coated substrate of Aspect 61, further comprising (c) a second film-forming composition applied on top of the first film-forming composition (b).

63. A coated substrate comprising:
(a) a surface impacted with a dopant comprising zinc phosphate; and
(b) a first film-forming composition applied to the impacted surface, wherein the first film-forming composition comprises a polysiloxane and optionally a polyepoxide.

64. A coated substrate comprising:
(a) a surface impacted with a dopant comprising magnesium oxide; and
(b) a first film-forming composition applied to the impacted surface, wherein the first film-forming composition comprises a polysiloxane resin and, optionally, an epoxy.

65. The coated substrate of Aspect 43 wherein the chemical is a sequence of different types of chemicals.

66. The coated substrate of Aspect 65 wherein the sequence of different types of chemicals comprises cyclic exposure to alcohol and water.

The invention will be further described by reference to the following examples. Unless otherwise indicated, all parts are by weight.

### EXAMPLES

### Application of Dopant and Coating Stack

The surfaces of cold and hot rolled steel panels were impacted with one of the following dopants listed in Table 1. The dopants were attached to the surface by the method described in patent publication WO2015140327. Following dopant application, each panel was sprayed with one or more of the PPG commercially available coatings listed in Table 2. The combinations of dopants and coating stacks is set out in Table 4.

TABLE 1

| Dopant | Supplier |
|---|---|
| Zinc Orthophosphate Hydrate (ZP10) | Heubach |
| Iron(III) Phosphate Hydrate | Alfa Aesar |
| Magnesium Oxide (MAGCHEM 200AD) | Martin Marietta |
| BPA Epoxy (DER663UE) | Dow Chemical |
| | Co. |
| BPA Epoxy (EPON Resin SU-8) | Hexion |
| BPA Epoxy (ARALDITE LT3366) | Huntsman |
| Novolac Epoxy (ARALDITE ECN1299) | Huntsman |

TABLE 2

| Coating | | |
|---|---|---|
| # | Coating(s) | Description |
| 1 | AMERLOCK 400 | Epoxy-amine primer, |
| | | pigmented |
| 2 | PSX 700 | Polysiloxane epoxy hybrid |
| | | topcoat |
| 3 | AMERCOAT 68HS primer with | Zinc rich epoxy primer with |
| | PSX 700 topcoat | polysiloxane epoxy hybrid |
| | | topcoat |
| 4 | NOVAGUARD 840 | Epoxy-amine tank liner |
| 5 | PHENGUARD 930/935/940 | Epoxy-amine tank liner |
| 6 | SPECTRACRON HPP | Polyurethane primer |
| 7 | SPECTRACRON SEP | Epoxy primer, pigmented |
| 8 | SPECTRACRON HPP primer | Polyurethane primer with |
| | with SPECTRACRON SPU | polyurethane topcoat |
| | topcoat | |
| 9 | SPECTRATRON SEP primer | Epoxy primer with |
| | with SPECTRACRON SPU | polyurethane topcoat |
| | topcoat | |
| 10 | AUE-370 | Polyurethane topcoat |
| 11 | CRE-321 primer with AUE-370 | Epoxy primer with |
| | topcoat | polyurethane topcoat |

Each of the coating(s) from Table 2 was applied and cured according to the details listed in Table 3.

TABLE 3

| | Approximate | Flash | Flash | | |
|---|---|---|---|---|---|
| | Dry Film | Time | Time | | |
| Coating | Thickness | Between | Before | Cure | Cure |
| # | (microns) | Coats | Bake | Time | Temperature |
| 1 | 190 | NA | NA | 2 weeks | RT |
| 2 | 140 | NA | NA | 2 weeks | RT |
| 3 | 100/130 | 1 day | NA | 2 weeks | RT |
| 4 | 350-400 | NA | NA | 20 days | RT |
| 5 | 340-350 | 1 day at | NA | 3 weeks | RT |
| | | RT | | | |
| | 340-350 | 1 day at | 2 | 1 day at | RT and |
| | | RT | weeks | 140° F. + | 140° F. |
| | | | | 3 days RT | |
| 6 | 60-75 | NA | 10 min | 30 min | 180° F. |
| | | | at RT | | |
| 7 | 60-75 | NA | 10 min | 30 min | 180° F. |
| | | | at RT | | |
| 8 | 60-75 per coat | 10 min at | 10 min | 30 min | 180° F. |
| | | RT | at RT | | |
| 9 | 60-75 per coat | 10 min at | 10 min | 30 min | 180° F. |
| | | RT | at RT | | |
| 10* | 76 | NA | NA | 7 days | RT |
| 11* | 60/85 | 1 hour at | NA | 7 days | RT |
| | | RT | | | |

*For coatings #10 and 11, each coating layer was applied as 2 wet coats
with a 15 minute flash at RT (room temperature; i. e., ambient conditions)
in between.

### Examples 1-17

### Corrosion Resistance Evaluation of Different Dopant and Protective Coating Combinations

Various combinations of dopants from Table 1 and coating(s) 1-3 from Table 2 were evaluated for corrosion resistance. The said coated and cured panels were scribed down to the metal substrate and then exposed to either 7 cycles of ISO20340 cyclic corrosion (13 cycles in the case of coating #3) or ASTM B117-11 salt fog for 1000 hours. After exposure, each panel was scraped at the scribe using a straight edged razor blade. The razor blade was used to remove as much of the coating around the scribe as could reasonably be scraped off without extraneous force. The average coating creep in these examples is defined as the average distance between the edge of the scraped coating on one side of the scribe line and the edge of the scraped coating on the opposite side of the scribe line. The average coating creep results are shown in Table 4.

TABLE 4

| | | | | | *Average | |
|---|---|---|---|---|---|---|
| | | | *Average | Standard | Cyclic | Standard |
| | | | Salt Fog | Deviation | Corrosion | Deviation |
| | | | Creep in | of Salt | Creep in | of Cyclic |
| Example # | Dopant | Coating(s) | mm | Fog Creep | mm | Creep |
| 1 | None (Control) | 1 | 8.90 | 0.96 | 8.45 | 1.27 |
| 2 | MAGCHEM | 1 | 3.33 | 0.57 | 6.15 | 0.80 |
| | 200AD | | | | | |
| 3 | ARALDITE | 1 | 4.44 | 1.15 | 5.34 | 0.69 |
| | ECN1299 | | | | | |
| 4 | ZP10 | 1 | 10.42 | 1.09 | 5.92 | 0.55 |
| 5 | None (Control) | 2 | 18.44 | 2.25 | 10.74 | 1.02 |
| 6 | DER663UE | 2 | 12.28 | 1.20 | 5.91 | 0.95 |
| 7 | Iron Phosphate | 2 | 33.29 | 2.40 | 8.93 | 0.52 |
| | Hydrate | | | | | |
| 8 | MAGCHEM | 2 | 2.26 | 0.48 | 5.66 | 0.84 |
| | 200AD | | | | | |
| 9 | ARALDITE | 2 | 12.80 | 0.78 | 6.82 | 0.85 |
| | ECN1299 | | | | | |
| 10 | SU-8 | 2 | 10.18 | 0.49 | 6.20 | 0.94 |
| 11 | ZP10 | 2 | 1.64 | 0.37 | 4.08 | 0.58 |
| 12 | None (Control) | 3 | 13.44 | 1.00 | 6.03 | 0.88 |
| 13 | DER663UE | 3 | 12.67 | 1.85 | 5.89 | 0.75 |
| 14 | MAGCHEM | 3 | 2.27 | 0.46 | 1.37 | 0.27 |
| | 200AD | | | | | |
| 15 | ARALDITE | 3 | 7.06 | 0.89 | 3.07 | 0.50 |
| | ECN1299 | | | | | |
| 16 | SU-8 | 3 | 8.24 | 0.62 | 4.65 | 0.30 |
| 17 | ZP10 | 3 | 4.72 | 3.58 | 2.41 | 0.21 |

As shown in Table 4, panels that were attached with a dopant and then coated with one or more coating layers showed improved corrosion performance

### Examples 18-29

### Chemical Resistance Evaluation of Different Dopant and Tank Lining Coating Combinations

Various combinations of dopants from Table 1 and coating(s) 4-5 from Table 2 were evaluated for chemical resistance. The chemical resistance was tested by immersion of coated test panels in a range of different chemicals in accordance with ISO 2812-1:2007. These tests are continuous exposures for a duration of 6 months with checks of the coating state at fixed intervals. The coatings were inspected for defects like blistering, cracking, swelling, delamination, softening, discoloration, adhesion, under film corrosion. In addition to continuous exposure testing wherein the panels are immersed in the same solution continuously, cyclic exposure testing was done, wherein coated panels were exposed intermittently to different chemicals to reflect cargo exposure in the current marine trade.

Table 5 lists the overall chemical resistance based on three test series. In total, 160 panels were evaluated in 26 chemicals tests, containing duplicates and triplicates. The overall chemical resistance is ranked from 1 to 4 with 1 being much better than the control and 4 representing no improvement as compared to the surface without the impaction treatment.

TABLE 5

| | | | Overall |
|---|---|---|---|
| | | | Chemical |
| Example | | | Resistance |
| # | DOPANT | Coating(s) | Rating |
| 18 | None (control) | 4 | 4 |
| 19 | None (control) | 5 | 4 |
| 20 | MAGCHEM 200AD | 5 | 2 |
| 21 | MAGCHEM 200AD | 4 | 3 |
| 22 | DER663UE | 5 | 3 |
| 23 | DER663UE | 4 | 3 |
| 24 | EPON SU-8 | 5 | 3 |
| 25 | EPON SU-8 | 4 | 3 |
| 26 | ARALDITE LT3366 | 5 | 3 |
| 27 | ARALDITE LT3366 | 4 | 3 |
| 28 | ARALDITE ECN1299 | 5 | 1 |
| 29 | ARALDITE ECN1299 | 4 | 2 |

As shown in Table 5, certain panels that were impacted with a dopant and then coated with one or more coating layers showed improved chemical resistance performance in comparison to control panels.

### Examples 30-43

### Corrosion Resistance Evaluation of Different Dopant and Industrial Coating Combinations

Various combinations of dopants from Table 1 and coatings 6-9 from Table 2 were evaluated for corrosion resistance. The coated panels were scribed down to the metal substrate and then exposed to an ASTM B117-11 salt-fog cabinet for 500 hours. After the 500 hour salt-fog exposure time, each panel was scraped at the scribe according to the guidelines provided in ASTM D1654-08. Panels were also scribed down to the metal substrate and exposed to 40 cycles of SAE J2334 cyclic corrosion. After exposure, each panel was visually inspected and given a rating from 1 to 3 based off of rust, blistering, and overall appearance. Panels ranked 1 showed improved corrosion resistance, and panels ranked 2 showed moderate improvement. The results are reported in Table 6.

TABLE 6

| | | | Salt | Cyclic |
|---|---|---|---|---|
| Example | | Coating | Fog | Corrosion |
| # | Dopant | Stack | Rating | Rating |
| 30 | None (Control) | 6 | 3 | 3 |
| 31 | None (Control) | 7 | 3 | 3 |
| 32 | None (Control) | 8 | 3 | 3 |
| 33 | None (Control) | 9 | 3 | 3 |
| 34 | DER663UE | 6 | 2 | 2 |
| 35 | EPON SU-8 | 7 | 1 | 2 |
| 36 | Iron Phosphate | 9 | 2 | 1 |
| 37 | MAGCHEM 200AD | 6 | 1 | 1 |
| 38 | MAGCHEM 200AD | 8 | 2 | 2 |
| 39 | MAGCHEM 200AD | 9 | 1 | 2 |
| 40 | ZP10 | 6 | 1 | 1 |
| 41 | ZP10 | 8 | 1 | 2 |
| 42 | ZP10 | 7 | 1 | 2 |
| 43 | ZP10 | 9 | 1 | 2 |

As shown in Table 6, panels that were impacted with a dopant and then coated with one or more coating layers showed improved corrosion resistance in comparison to the control panels.

### Examples 44-51

### Corrosion Resistance Evaluation of Different Dopant and Automotive Refinish Coating Combinations

Various combinations of dopants from Table 1 and coatings 10-11 from Table 2 were evaluated for corrosion resistance. The coated panels were scribed down to the metal substrate and then exposed to an ASTM B117-11 salt-fog cabinet for 1000 and 1500 hours for single and multi-coat systems respectively. Coated and scribed panels were also exposed to 40 cycles of SAE J2334 cyclic corrosion. After exposure, each panel was scraped at the scribe according to the guidelines provided in ASTM D1654-08 and measured in millimeters for corrosion creep at the scribe. The average corrosion creep results are shown in Table 7.

TABLE 7

| | | | Average | Standard | Average | Standard |
|---|---|---|---|---|---|---|
| | | | Salt Fog | Deviation | Cyclic | Deviation |
| | | | Creep in | of Salt | Creep in | of Cyclic |
| Example # | Dopant | Coating(s) | mm | Fog Creep | mm | Creep |
| 45 | None (Control) | 10 | 4.20 | 3.08 | NA | NA |
| 46 | EPON ECN1299 | 10 | 3.62 | 1.32 | 4.49 | 1.60 |
| 47 | None (Control) | 11 | 8.92 | 2.42 | 3.62 | 0.85 |
| 48 | ZP10 | 11 | 5.63 | 1.45 | 2.28 | 0.68 |
| 49 | Iron Phosphate | 11 | 33.30 | 2.47 | 2.37 | 0.67 |
| 50 | MAGCHEM 200AD | 11 | 3.58 | 0.54 | 3.32 | 0.73 |
| 51 | EPON ECN1299 | 11 | 4.47 | 1.17 | 4.03 | 0.72 |

As shown in Table 7, panels that were impacted with a dopant and then coated with one or more coating layers showed improved corrosion performance in comparison to the control panels.

### Examples 52-55

The surfaces of cold rolled steel panels were impacted with magnesium oxide (MgO) dopant from Table 1. The dopant was mixed with Speedway Motors 50-80 sieve mesh aluminum oxide to give a composition comprising 20 percent by volume (20 vol %) MgO based on the packed or agglomerated density. Half the experimental panels were blasted first with aluminum oxide and then with the 20 percent by volume MgO mix. The remaining experimental panels were blasted with the 20 vol % MgO mix only. The control panels were blasted using aluminum oxide only. All panels achieved a blast profile of 1-1.3 mils as measured by Press-O-Film. Each of the blasted panels were coated with PPG PSX™ 700 as described in Table 3.

### Testing and Evaluation

The coated panels of Examples 52-55 were scribed down to the metal substrate and then exposed to ASTM B117-11 salt fog for 1000 hours. After exposure, each panel was scraped at the scribe using a straight edged razor blade. The razor blade was used to remove as much of the coating around the scribe as could reasonably be scraped off without extraneous force. The average coating creep in these examples is defined as the average distance between the edge of the scraped coating on one side of the scribe line and the edge of the scraped coating on the opposite side of the scribe line. The average rust creep is defined in the same manner as the average distance between the edges of the rust. The average results are shown in Table 8.

TABLE 8

| | | | Coating | | Rust |
|---|---|---|---|---|---|
| | | Coating | Creep | Rust | Creep |
| Example | Abrasive Media | Creep | Standard | Creep | Standard |
| # | Used | (mm) | deviation | (mm) | Deviations |
| 52 | G40 steel grit | Complete | NA | 7.34 | 3.61 |
| | | failure | | | |
| 53 | Aluminum oxide | 17.67 | 2.51 | 5.71 | 2.19 |
| 54 | Aluminum oxide/ | 4.50 | 0.95 | 3.30 | 0.65 |
| | MgO mix | | | | |
| 55 | 1. Aluminum oxide | 5.36 | | | |
| | 2. Aluminum oxide/ | | 1.14 | 3.55 | 0.73 |
| | MgO mix | | | | |

As shown in Table 8, panels that were impacted with magnesium oxide and then coated with polysiloxane (Examples 54-55) showed improved corrosion resistance over both steel grit and aluminum oxide blasted cold rolled steel.

Whereas particular embodiments of this invention have been described above for purposes of illustration, it will be evident to those skilled in the art that numerous variations of the details of the present invention may be made without departing from the scope of the invention as defined in the aspects.

1. A coated substrate comprising:
(a) a surface that has been impacted with an abrasive particle and a dopant such that at least a portion of the surface becomes attached with the dopant;
(b) a first film-forming composition on at least a portion of the dopant-attached surface, wherein the surface is impacted substantially simultaneously with the abrasive particle and the dopant.

2. The substrate of claim 1, wherein the dopant comprises a corrosion inhibitor other than zinc phosphate or iron phosphate.

3. The substrate of claim 2, wherein the dopant comprises magnesium oxide and/or an epoxy resin.

4. The substrate of claim 3, wherein the dopant comprises magnesium oxide.

5. The coated substrate of claim 2, wherein the first film-forming composition comprises a resin selected from a polysiloxane, an epoxy resin optionally comprising zinc and/or a pigment, a polyurethane and combinations thereof.

6. The coated substrate of claim 4, wherein the first film-forming composition comprises a resin selected from a polysiloxane, an epoxy resin optionally comprising zinc and/or a pigment, a polyurethane and combinations thereof.

7. The coated substrate of claim 1, wherein the dopant comprises a corrosion inhibitor other than iron phosphate and the first film-forming composition comprises a polysiloxane or a polyurethane.

8. The coated substrate of claim 7, wherein the film-forming composition comprises a polysiloxane and optionally an epoxy resin.

9. The coated substrate of claim 1, wherein the dopant comprises a corrosion inhibitor and the first film-forming composition comprises zinc or pigments.

10. The coated substrate of claim 7, wherein the corrosion inhibitor comprises zinc phosphate, magnesium oxide, an epoxy resin or combinations thereof.

11. The coated substrate of claim, further comprising a second film-forming composition applied to at least a portion of the first film-forming layer.

12. The coated substrate of claim 11, wherein the second film-forming composition comprises a resin selected from polysiloxane, epoxy resin, polyurethane and combinations thereof.

13. The coated substrate of claim 1, wherein the dopant comprises magnesium oxide, the first film-forming composition comprises zinc, and further comprising a second film-forming composition applied on top of the first film-forming composition, the second film-forming composition comprising a polysiloxane and optionally a polyepoxide.

14. The coated substrate according to claim 13, wherein the first film-forming composition further comprises a polyepoxide and/or a silicate or any other ceramic.

15. The coated substrate of claim 1, wherein the dopant comprises a novolac epoxy resin, and the film-forming composition comprises a polyepoxide.

16. The coated substrate of claim 15, wherein the coated substrate demonstrates resistance to a fatty acid as measured by ISO 2812-1:2007.

17. A coated substrate of claim 1, wherein the dopant comprises zinc phosphate, and the first film-forming composition comprises zinc, and further comprising a second film-forming composition applied on top of the first film-forming composition, the second film-forming composition comprising a polysiloxane and optionally a polyepoxide.

18. (canceled)

19. A coated substrate of claim 1 in which the film-forming composition comprises a pre-fabricated shop coating or shop primer.

20. An article comprising the substrate of claim 1 suitably selected from a vehicle, an industrial protective structure, transformer housing, motor control enclosure; railcar container, tunnel, oil or gas industry component suitably selected from platforms, pipes, tanks, vessels, and their supports, marine components, automotive body parts, aerospace components, pipelines, storage tanks, wind turbine components, general purpose steel specimen.

21. A coated substrate comprising:
(a) a surface that has been impacted with an abrasive particle and a dopant such that at least a portion of the surface becomes attached with the dopant;
(b) a first film-forming composition on at least a portion of the dopant-attached surface, wherein the surface is impacted substantially simultaneously with the abrasive particle and the dopant; and optionally
c) a second film-forming composition, wherein the surface is impacted substantially simultaneously with the abrasive particle and the dopant, wherein at least one of the film-forming compositions demonstrates intumescence.
